(19) United States
(12) Patent Application Publication
(10) Pub. No.: US 2026/0319383 A1
(43) Pub. Date: Oct. 15, 2026

(54) METHOD AND SYSTEM FOR PREDICTING AFTER-DEVELOPMENT STOCHASTIC EFFECTS FOR FULL CHIP APPLICATIONS

(71) Applicant: ASML NETHERLANDS B.V., Veldhoven (NL)

(72) Inventors: Yongfa FAN, Cupertino, CA (US); Mu FENG, San Jose, CA (US); Duan-Fu Stephen HSU, Fremont, CA (US); Xu XIE, Fremont, CA (US); Chang An WANG, Poughkeepsie, NY (US)

(73) Assignee: ASML NETHERLANDS B.V., Veldhoven (NL)

(21) Appl. No.: 19/482,995

(22) PCT Filed: May 3, 2024
(86) PCT No.: PCT/EP2024/062364

§ 371 Date: Nov. 10, 2025

Related U.S. Application Data
(60) Provisional application No. 63/469,461, filed on May 29, 2023.

(51) Int. Cl. G03F 7/00; G06T 7/00; G06T 7/13; G06T 7/33; G06T 7/73

(52) U.S. Cl. CPC G03F 7/706839; G03F 7/70625; G03F 7/70653; G03F 7/706837; G03F 7/706845; G06T 7/0004; G06T 7/13; G06T 7/337; G06T 7/73; G06T 2207/20076; G06T 2207/30148

(57) ABSTRACT

A method and system for simulating stochastic effect in a lithography process. An image of a pattern area is obtained and a photon probability distribution (PD) at each location of the pattern area is determined based on image intensity at the corresponding location. A failure probability map of an after-development image of the pattern area is determined based on the photon PD. The failure probability map is a continuous map that enables determination of a failure probability (e.g., tone-flipping probability) at any location of the pattern area.

### CROSS REFERENCE TO RELATED APPLICATION

This application claims priority to U.S. Application No. 63/469,461, filed May 29, 2023, and which is incorporated herein in its entirety by reference.

### TECHNICAL FIELD

The embodiments provided herein relate to semiconductor manufacturing, and more particularly to predicting after-development stochastic effects.

### BACKGROUND

A lithographic apparatus is a machine that applies a desired pattern onto a target portion of a substrate. The lithographic apparatus can be used, for example, in the manufacture of integrated circuits (ICs). For example, an IC chip in a smart phone, can be as small as a person's thumbnail, and may include over 2 billion transistors. Making an IC is a complex and time-consuming process, with circuit components in different layers and including hundreds of individual steps. Errors in even one step have the potential to result in problems with the final IC and can cause device failure. High process yield and high wafer throughput can be impacted by the presence of defects.

### BRIEF SUMMARY

In some aspects, the techniques described herein relate to a method for simulating stochastic effect in a lithography process, the method including: obtaining an image of a pattern area; determining photon probability distribution (PD) at each location of the pattern area based on image intensity at the corresponding location; and determining a failure probability map of an after-development image of the pattern area based on the photon PD, wherein the failure probability map is a continuous map that enables determination of a failure probability at any location of the pattern area.

In some aspects, the techniques described herein relate to a method for determining stochastic effect in a lithography process, the method including: aligning a set of images of a pattern; determining pixel intensity distribution of each location in the pattern from the set of images; and determining stochastic errors of the pattern based on the pixel intensity distribution.

In some embodiments, there is provided a non-transitory computer readable medium having instructions that, when executed by a computer, cause the computer to execute a method of any of the above embodiments.

In some embodiments, there is provided an apparatus includes a memory storing a set of instructions and a processor configured to execute the set of instructions to cause the apparatus to perform a method of any of the above embodiments.

### BRIEF DESCRIPTION OF THE DRAWINGS

Embodiments will now be described, by way of example only, with reference to the accompanying drawings in which:

FIG. 1 illustrates a block diagram of various subsystems of a lithographic projection apparatus, according to an embodiment.

FIG. 2 is a schematic diagram of a lithographic projection apparatus, according to an embodiment.

FIG. 3 illustrates an exemplary flow chart for simulating lithography in a lithographic projection apparatus, according to an embodiment.

FIG. 4 is an illustration of pinching and bridging in a lithography process, consistent with various.

FIG. 5 shows a simulation of failure probability of a pattern area based on photon probability distribution across the pattern area, consistent with various embodiments.

FIG. 6 is a block diagram of an exemplary system for simulating stochastic effects based on an image representation of a pattern, consistent with various embodiments.

FIG. 7 is a flow diagram of an exemplary method for simulating stochastic effects based on an image representation of a pattern, consistent with various embodiments.

FIG. 8 is a graph illustrating modelling of mean critical dimension of a pattern based on the simulation of stochastic effects, consistent with various embodiments.

FIG. 9 illustrates another application of simulation of stochastic effects using an image representation of a pattern, consistent with various embodiments.

FIG. 10 illustrates an application of simulation of stochastic effects using an image representation of a pattern for a source mask optimization (SMO) process, consistent with various embodiments.

FIG. 11 is a block diagram of an exemplary system for determining stochastic variation in a pattern based on pixel intensity distribution, consistent with various embodiments.

FIG. 12 is a flow diagram of a method for determining stochastic variation in a pattern based on pixel intensity distribution, consistent with various embodiments.

FIG. 13 is a flow diagram of a method for calibrating an imaging model to generate an image representation of a pattern, consistent with various embodiments.

FIG. 14 is a block diagram of an example computer system, according to an embodiment.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

A lithographic apparatus is a machine that applies a designed pattern onto a target portion of a substrate. This process of transferring the designed pattern to the substrate is called a patterning process or a lithography process. The patterning process can include a patterning step to transfer a pattern from a patterning device (such as a mask) to the substrate. Various variations (e.g., variations in the patterning process or the lithographic apparatus) can potentially limit lithography implementation for semiconductor high volume manufacturing (HVM). For example, photon number or energy variations in an illumination source of the lithographic apparatus, focus or dose variations in projection optics of the lithographic apparatus, molecular size or photoacid diffusion variations in resist chemistry, plasma density distribution and pattern density variations in etch process etc. can lead to stochastic effects, such as pronounced line edge roughness (LER), line width roughness (LWR), edge placement errors (EPE—e.g., a distance between a point in a resist image to an intended position of that point in a target layout or design layout), local critical dimension uniformity (LCDU), or local critical dimension (CD) variation in small two-dimensional features of the pattern.

Certain stochastic models may predict stochastic variations such as variations in CD or stochastic edge placement error (SEPE) based on predicted resist contours (e.g., contours of a pattern on resist after a substrate is exposed to the pattern using a lithographic process in a lithographic apparatus). However, the conventional stochastic models may have some drawbacks. For example, some conventional stochastic models assume stochastic CD variations follow Gaussian distribution with respect to average CD, which may be accurate for certain CD variations (e.g., up to 2 or 3 sigma's (99.7% corresponds to 3sigma)). However, CD variations at other sigma values (e.g., 5 or 6 sigma) may not necessarily follow Gaussian distribution, which may lead the models to provide inaccurate predictions. Further, some conventional stochastic models also assume the stochastic variations are symmetric in nature. For example, the conventional stochastic models may assume the same failure probability for a CD of 10 nm larger or smaller than the average CD. That is, in a failure scenario, the conventional stochastic models may assume the pinching and bridging have the same probability (e.g., if they have equal distance from the average CD).

Disclosed are embodiments for simulating stochastic effects in a lithography process using a Poisson distribution, such as photon probability distribution (PD) across a pattern area. A failure probability map that is indicative of a tone-flipping probability may be determined based on the photon PD across the pattern area. An image representation of a pattern (e.g., a resist image) may be used to evaluate the “tone-flipping” probability at any arbitrary location in the pattern area, which is indicative of a combination of the probability of a resist remaining in a particular location where it is supposed to be removed (e.g., pinching) and probability of a resist being removed from a particular location where it is supposed to remain (e.g., bridging), due to shot noise or other factors causing the stochastic effects. An image signal (e.g., resist image intensity) is obtained from a resist image of the pattern area and a photon PD across each location of the pattern area is determined using the image signal at the corresponding location. The failure probability may be determined based on the photon PD and a photon threshold number. For example, the probability of pinching may be calculated by the probability of a peak of the image intensity signal falling below an image intensity threshold, which is determined as a probability of the number of photons dropping below the photon threshold number. Similarly, the probability of bridging, which is the probability of a negative peak (or valley) of the image intensity signal exceeding the image intensity threshold is determined as a probability of the number of photons exceeding the photon threshold number. In some embodiments, the photon threshold number corresponds to an image intensity threshold, which is an intensity threshold level above which a resist is developed.

The failure probability map may be a continuous map (e.g., a pixel-based map) in which each pixel indicates a tone-flipping probability at a corresponding location in the pattern. The failure probability map may be determined for the pattern at a full-chip level. For example, the disclosed embodiments may use a lithographic model that is calibrated to generate an image representation of the pattern (e.g., a resist image) at a full-chip level, obtain an image intensity at a desired area of the pattern and determine the failure probability at the desired area (e.g., as described above). By using an image intensity signal to determine the failure probability at any desired area in the pattern at the full-chip level, the disclosed embodiments enable a more accurate determination of the failure probability for any type of CD variations (e.g., not just Gaussian distribution) and regardless of whether the stochastic variations are symmetric in nature.

Some conventional methods determine stochastic effects using metrology data, particularly using LWR and LCDU to measure stochastic variation for one dimensional pattern (e.g., line pattern) and two-dimensional (2D) (e.g., contact hole), respectively. A ratio of defect count/total inspection sites or CD distribution-based soft defect probability is used to estimate failure probability for highly repeated patterns. However, the conventional methods have some drawbacks. For example, the measurements are conducted at selected few locations without the context of the entire pattern. They are strongly dependent on pattern type, not comparable across pattern types, not unified, may not work for non-repeating or low-repeating patterns (e.g., random patterns).

The disclosed embodiments determine stochastic variation of a certain pattern based on pixel intensity variance in repeating images of the certain pattern. Several measured images of the pattern (e.g., SEM images or other metrology images) are obtained and grouped based on optical equivalence to obtain a set of images. In some embodiments, two images of a pattern at different locations of a substrate are considered to be optically equivalent if their optical proximity effects are the same. In some embodiments, optical proximity effects are the variations in the linewidth of a feature (or the shape for a 2D pattern) as a function of the proximity of other nearby features. The set of images can be aligned (e.g., with a target pattern) and processed to remove noise and distortion. Pixel intensity distribution is determined for each location of the pattern across the set of images and a failure probability map, or a stochastic failure map, is generated therefrom. For example, based on the pixel intensity distribution, various metrics such as standard deviation, slope, or full width at half maximum (FWHM) may be calculated for each location of the pattern, which may be used to determine the stochastic failure (e.g., stochastic EPE (SEPE)). In some embodiments, a stochastic failure map May be an image in which each pixel is indicative of a failure probability at the corresponding location in the pattern. Similarly, based on the pixel intensity distribution, a failure probability may be calculated at a particular location. For example, the failure probability may be calculated based on (a) a first portion of the pixel intensity distribution below a first pixel intensity threshold (e.g., occurrence of pinching), (b) a second portion of the pixel intensity distribution above a second pixel intensity threshold (e.g., occurrence of bridging), and (c) a region corresponding to the entire pixel intensity distribution. The failure probability is represented by a tone-flipping probability at the particular location. In some embodiments, the failure probability map may be generated as an image in which each pixel is indicative of the tone-flipping probability at the corresponding location in the pattern. By using the pixel intensity distribution of the pattern across several images, the disclosed embodiments may determine the stochastic variation being independent of the pattern types, provide comparable results across pattern types, and may be used for non-repeating or low-repeating patterns (e.g., random patterns). In some embodiments, the above method of determining the failure probability using the pixel intensity variation across images of the pattern may be used in calibrating a lithographic model to generate an image of the pattern (e.g., resist image), which is used in simulating the stochastic effects as described above.

In the present disclosure, although specific reference may be made to the manufacture of ICs, it should be explicitly understood that the description herein has many other possible applications. For example, it may be employed in the manufacture of integrated optical systems, guidance and detection patterns for magnetic domain memories, liquid crystal display panels, thin film magnetic heads, etc. The skilled artisan will appreciate that, in the context of such alternative applications, any use of the terms “reticle”, “wafer” or “die” in this text should be considered as interchangeable with the more general terms “mask”, “substrate” and “target portion”, respectively.

In the present document, the terms “radiation” and “beam” are used to encompass all types of electromagnetic radiation, including ultraviolet radiation (e.g., with a wavelength of 365, 248, 193, 157 or 126 nm) and EUV (extreme ultra-violet radiation, e.g., having a wavelength in the range of about 5-100 nm). In the present document, the term “radiation source” or “source” is used to encompass all types of sources of radiation, including laser sources, incandescent sources, etc. which may include treatment of the radiation between the radiation source and the target or other parts of the optics, including filtering, collimating, focusing, etc.

A patterning device can comprise, or can form, one or more design layouts. The design layout can be generated utilizing CAD (computer-aided design) programs. This process is often referred to as EDA (electronic design automation). Most CAD programs follow a set of predetermined design rules in order to create functional design layouts/patterning devices. These rules are set based processing and design limitations. For example, design rules define the space tolerance between devices (such as gates, capacitors, etc.) or interconnect lines, to ensure that the devices or lines do not interact with one another in an undesirable way. One or more of the design rule limitations may be referred to as a “critical dimension” (CD). A critical dimension of a device can be defined as the smallest width of a line or hole, or the smallest space between two lines or two holes. Thus, the CD regulates the overall size and density of the designed device. One of the goals in device fabrication is to faithfully reproduce the original design intent on the substrate (via the patterning device).

The term “mask” or “patterning device” as employed in this text may be broadly interpreted as referring to a generic patterning device that can be used to endow an incoming radiation beam with a patterned cross-section, corresponding to a pattern that is to be created in a target portion of the substrate. The term “light valve” can also be used in this context. Besides the classic mask (transmissive or reflective; binary, phase-shifting, hybrid, etc.), examples of other such patterning devices include a programmable mirror array. An example of such a device is a matrix-addressable surface having a viscoelastic control layer and a reflective surface. The basic principle behind such an apparatus is that (for example) addressed areas of the reflective surface reflect incident radiation as diffracted radiation, whereas unaddressed areas reflect incident radiation as undiffracted radiation. Using an appropriate filter, the said undiffracted radiation can be filtered out of the reflected beam, leaving only the diffracted radiation behind; in this manner, the beam becomes patterned according to the addressing pattern of the matrix-addressable surface. The required matrix addressing can be performed using suitable electronic means. Examples of other such patterning devices also include a programmable LCD array. An example of such a construction is given in U.S. Pat. No. 5,229,872, which is incorporated herein by reference.

The term “projection optics” as used herein should be broadly interpreted as encompassing various types of optical systems, including refractive optics, reflective optics, apertures and catadioptric optics, for example. The term “projection optics” may also include components operating according to any of these design types for directing, shaping, or controlling the projection beam of radiation, collectively or singularly. The term “projection optics” may include any optical component in the lithographic projection apparatus, no matter where the optical component is located on an optical path of the lithographic projection apparatus. Projection optics may include optical components for shaping, adjusting and/or projecting radiation from the source before the radiation passes the patterning device, and/or optical components for shaping, adjusting and/or projecting the radiation after the radiation passes the patterning device. The projection optics generally exclude the source and the patterning device.

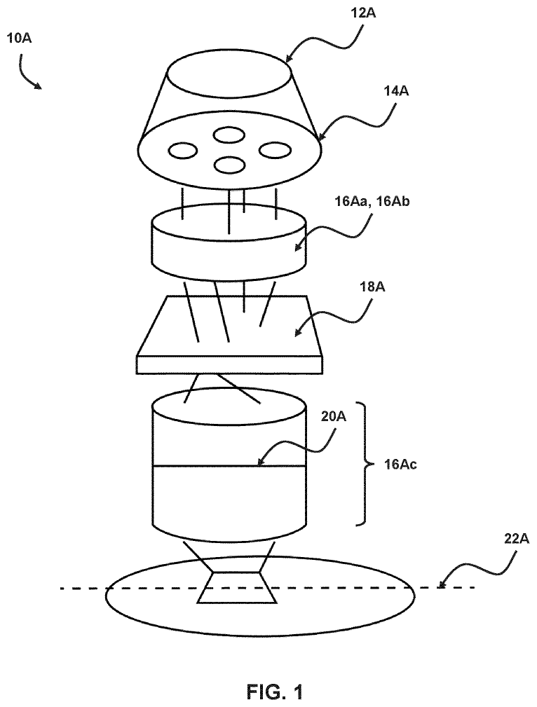

FIG. 1 illustrates a block diagram of various subsystems of a lithographic projection apparatus 10A, according to an embodiment. Major components are a radiation source 12A, which may be a deep-ultraviolet excimer laser source or other type of source including an extreme ultra violet (EUV) source (the lithographic projection apparatus itself need not have the radiation source), illumination optics which, e.g., define the partial coherence (denoted as sigma) and which may include optics 14A, 16Aa and 16Ab that shape radiation from the source 12A; a patterning device (or mask) 18A; and transmission optics 16Ac that project an image of the patterning device pattern onto a substrate plane 22A.

A pupil 20A can be included with transmission optics 16Ac. In some embodiments, there can be one or more pupils before and/or after mask 18A. As described in further detail herein, pupil 20A can provide patterning of the light that ultimately reaches substrate plane 22A. An adjustable filter or aperture at the pupil plane of the projection optics may restrict the range of beam angles that impinge on the substrate plane 22A, where the largest possible angle defines the numerical aperture of the projection optics NA=n sin(Θmax), wherein n is the refractive index of the media between the substrate and the last element of the projection optics, and Θmax is the largest angle of the beam exiting from the projection optics that can still impinge on the substrate plane 22A.

In a lithographic projection apparatus, a source provides illumination (i.e., radiation) to a patterning device and projection optics direct and shape the illumination, via the patterning device, onto a substrate. This is not to disclaim that the source does not itself provide patterning, directing, or shaping to the radiation or that patterning, directing, or shaping does not occur between the source and the projection optics. The projection optics may include at least some of the components 14A, 16Aa, 16Ab and 16Ac. An aerial image (AI) is the radiation intensity distribution at substrate level. A resist model can be used to calculate the resist image from the aerial image, an example of which can be found in U.S. Patent Application Publication No. US 2009-0157360, the disclosure of which is hereby incorporated by reference in its entirety. The resist model is related to properties of the resist layer (e.g., effects of chemical processes which occur during exposure, post-exposure bake (PEB) and development). Optical properties of the lithographic projection apparatus (e.g., properties of the illumination, the patterning device, and the projection optics) dictate the aerial image and can be defined in an optical model. Since the patterning device used in the lithographic projection apparatus can be changed, it is desirable to separate the optical properties of the patterning device from the optical properties of the rest of the lithographic projection apparatus including at least the source and the projection optics. Details of techniques and models used to transform a design layout into various lithographic images (e.g., an aerial image, a resist image, etc.), apply OPC using those techniques and models and evaluate performance (e.g., in terms of process window) are described in U.S. Patent Application Publication Nos. US 2008-0301620, 2007-0050749, 2007-0031745, 2008-0309897, 2010-0162197, and 2010-0180251, the disclosure of each which is hereby incorporated by reference in its entirety.

One aspect of understanding a lithographic process is understanding the interaction of the radiation and the patterning device. The electromagnetic field of the radiation after the radiation passes the patterning device may be determined from the electromagnetic field of the radiation before the radiation reaches the patterning device and a function that characterizes the interaction. This function may be referred to as the mask transmission function (which can be used to describe the interaction by a transmissive patterning device and/or a reflective patterning device).

The mask transmission function may have a variety of different forms. One form is binary. A binary mask transmission function has either of two values (e.g., zero and a positive constant) at any given location on the patterning device. A mask transmission function in the binary form may be referred to as a binary mask. Another form is continuous. Namely, the modulus of the transmittance (or reflectance) of the patterning device is a continuous function of the location on the patterning device. The phase of the transmittance (or reflectance) may also be a continuous function of the location on the patterning device. A mask transmission function in the continuous form may be referred to as a continuous tone mask or a continuous transmission mask (CTM). For example, the CTM may be represented as a pixelated image, where each pixel may be assigned a value between 0 and 1 (e.g., 0.1, 0.2, 0.3, etc.) instead of binary value of either 0 or 1. In an embodiment, CTM may be a pixelated gray scale image, where each pixel having values (e.g., within a range [−255, 255], normalized values within a range [0, 1] or [−1, 1] or other appropriate ranges).

The thin-mask approximation, also called the Kirchhoff boundary condition, is widely used to simplify the determination of the interaction of the radiation and the patterning device. The thin-mask approximation assumes that the thickness of the structures on the patterning device is very small compared with the wavelength and that the widths of the structures on the mask are very large compared with the wavelength. Therefore, the thin-mask approximation assumes the electromagnetic field after the patterning device is the multiplication of the incident electromagnetic field with the mask transmission function. However, as lithographic processes use radiation of shorter and shorter wavelengths, and the structures on the patterning device become smaller and smaller, the assumption of the thin-mask approximation can break down. For example, interaction of the radiation with the structures (e.g., edges between the top surface and a sidewall) because of their finite thicknesses (“mask 3D effect” or “M3D”) may become significant. Encompassing this scattering in the mask transmission function may enable the mask transmission function to better capture the interaction of the radiation with the patterning device. A mask transmission function under the thin-mask approximation may be referred to as a thin-mask transmission function. A mask transmission function encompassing M3D may be referred to as a M3D mask transmission function.

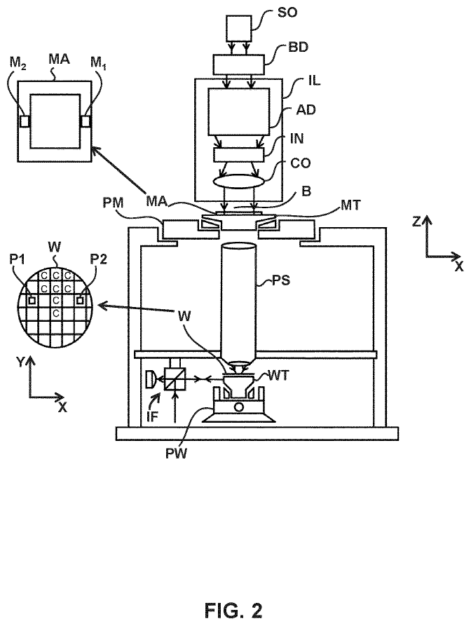

FIG. 2 schematically depicts an exemplary lithographic projection apparatus whose illumination source could be optimized utilizing the methods described herein. The apparatus comprises:
an illumination system IL, to condition a beam B of radiation. In this particular case, the illumination system also comprises a radiation source SO;
a first object table (e.g., mask table, patterning device table or reticle stage) MT provided with a patterning device holder to hold a patterning device MA (e.g., a reticle), and connected to a first positioner to accurately position the patterning device with respect to item PS;
a second object table (substrate table or wafer stage) WT provided with a substrate holder to hold a substrate W (e.g., a resist-coated silicon wafer), and connected to a second positioner to accurately position the substrate with respect to item PS;
a projection system (“lens”) PS (e.g., a refractive, catoptric or catadioptric optical system) to image an irradiated portion of the patterning device MA onto a target portion C (e.g., comprising one or more dies) of the substrate W.

As depicted herein, the apparatus is of a transmissive type (i.e., has a transmissive mask). However, in general, it may also be of a reflective type, for example (with a reflective mask). Alternatively, the apparatus may employ another kind of patterning device as an alternative to the use of a classic mask; examples include a programmable mirror array or LCD matrix.

The source SO (e.g., a mercury lamp or excimer laser) produces a beam of radiation. This beam is fed into an illumination system (illuminator) IL, either directly or after having traversed conditioning means, such as a beam expander Ex, for example. The illuminator IL may comprise adjusting means AD for setting the outer or inner radial extent (commonly referred to as σ-outer and σ-inner, respectively) of the intensity distribution in the beam. In addition, it will generally comprise various other components, such as an integrator IN and a condenser CO. In this way, the beam B impinging on the patterning device MA has a desired uniformity and intensity distribution in its cross-section.

It should be noted with regard to FIG. 2 that the source SO may be within the housing of the lithographic projection apparatus (as is often the case when the source SO is a mercury lamp, for example), but that it may also be remote from the lithographic projection apparatus, the radiation beam that it produces being led into the apparatus (e.g., with the aid of suitable directing mirrors); this latter scenario is often the case when the source SO is an excimer laser (e.g., based on KrF, ArF or F₂ lasing).

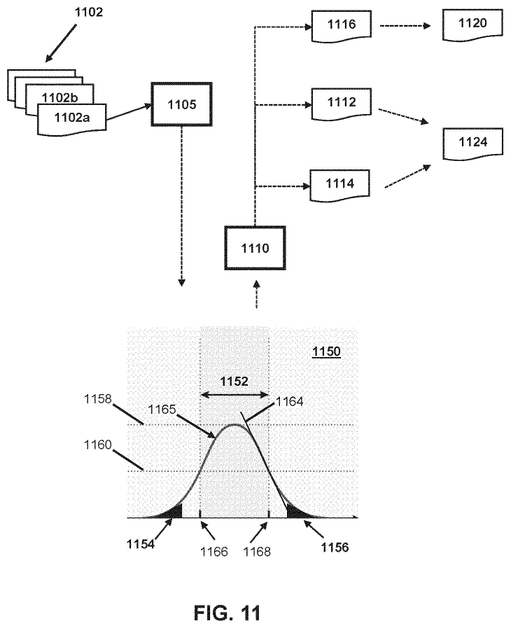

The beam B subsequently intercepts the patterning device MA, which is held on a patterning device table MT. Having traversed the patterning device MA, the beam B passes through the lens PS, which focuses the beam B onto a target portion C of the substrate W. With the aid of the second positioning means (and interferometric measuring means IF), the substrate table WT can be moved accurately, e.g., so as to position different target portions C in the path of beam B. Similarly, the first positioning means can be used to accurately position the patterning device MA with respect to the path of the beam B, e.g., after mechanical retrieval of the patterning device MA from a patterning device library, or during a scan. In general, movement of the object tables MT, WT will be realized with the aid of a long-stroke module (coarse positioning) and a short-stroke module (fine positioning), which are not explicitly depicted in FIG. 11. However, in the case of a wafer stepper (as opposed to a step-and-scan tool) the patterning device table MT may just be connected to a short stroke actuator or may be fixed.

The depicted tool can be used in two different modes:
In step mode, the patterning device table MT is kept essentially stationary, and an entire patterning device image is projected in one go (i.e., a single “flash”) onto a target portion C. The substrate table WT is then shifted in the x or y directions so that a different target portion C can be irradiated by the beam B;
In scan mode, essentially the same scenario applies, except that a given target portion C is not exposed in a single “flash”. Instead, the patterning device table MT is movable in a given direction (the so-called “scan direction”, e.g., the y direction) with a speed v, so that the projection beam B is caused to scan over a patterning device image; concurrently, the substrate table WT is simultaneously moved in the same or opposite direction at a speed V=Mv, in which M is the magnification of the lens PS (typically, M=1/4 or 1/5). In this manner, a relatively large target portion C can be exposed, without having to compromise on resolution.

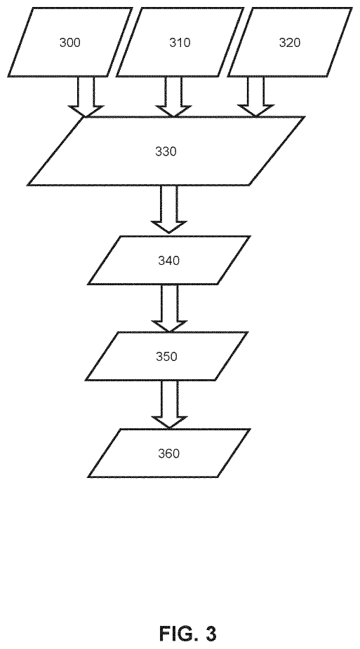

FIG. 3 illustrates an exemplary flow chart for simulating lithography in a lithographic projection apparatus, according to an embodiment. As will be appreciated, the models may represent a different patterning process and need not comprise all the models described below. A source model 300 represents optical characteristics (including radiation intensity distribution, bandwidth and/or phase distribution) of the illumination of a patterning device. The source model 300 can represent the optical characteristics of the illumination that include, but not limited to, numerical aperture settings, illumination sigma (o) settings as well as any particular illumination shape (e.g., off-axis radiation shape such as annular, quadrupole, dipole, etc.), where σ (or sigma) is outer radial extent of the illuminator.

A projection optics model 310 represents optical characteristics (including changes to the radiation intensity distribution and/or the phase distribution caused by the projection optics) of the projection optics. The projection optics model 310 can represent the optical characteristics of the projection optics, including aberration, distortion, one or more refractive indexes, one or more physical sizes, one or more physical dimensions, etc.

The patterning device/design layout model module 320 captures how the design features are laid out in the pattern of the patterning device and may include a representation of detailed physical properties of the patterning device, as described, for example, in U.S. Pat. No. 7,587,704, which is incorporated by reference in its entirety. In an embodiment, the patterning device/design layout model module 320 represents optical characteristics (including changes to the radiation intensity distribution and/or the phase distribution caused by a given design layout) of a design layout (e.g., a device design layout corresponding to a feature of an integrated circuit, a memory, an electronic device, etc.), which is the representation of an arrangement of features on or formed by the patterning device. Since the patterning device used in the lithographic projection apparatus can be changed, it is desirable to separate the optical properties of the patterning device from the optical properties of the rest of the lithographic projection apparatus including at least the illumination and the projection optics. The objective of the simulation is often to accurately predict, for example, edge placements and CDs, which can then be compared against the device design. The device design is generally defined as the pre-OPC patterning device layout and will be provided in a standardized digital file format such as GDSII or OASIS.

An aerial image 330 can be simulated from the source model 300, the projection optics model 310 and the patterning device/design layout model module 320. An aerial image (AI) is the radiation intensity distribution at substrate level. Optical properties of the lithographic projection apparatus (e.g., properties of the illumination, the patterning device, and the projection optics) dictate the aerial image.

A resist layer on a substrate is exposed by the aerial image and the aerial image is transferred to the resist layer as a latent “resist image” (RI) therein. The resist image (RI) can be defined as a spatial distribution of solubility of the resist in the resist layer. A resist image 350 can be simulated from the aerial image 330 using a resist model 340. The resist model can be used to calculate the resist image from the aerial image, an example of which can be found in U.S. Patent Application No. 8,200,468, the disclosure of which is hereby incorporated by reference in its entirety. The resist model 340 typically describes the effects of chemical processes which occur during resist exposure, post exposure bake (PEB) and development, in order to predict, for example, contours of resist features formed on the substrate and so it typically related only to such properties of the resist layer (e.g., effects of chemical processes which occur during exposure, post-exposure bake and development). In an embodiment, the optical properties of the resist layer, e.g., refractive index, film thickness, propagation, and polarization effects—may be captured as part of the projection optics model 310.

So, in general, the connection between the optical and the resist model is a simulated aerial image intensity within the resist layer, which arises from the projection of radiation onto the substrate, refraction at the resist interface and multiple reflections in the resist film stack. The radiation intensity distribution (aerial image intensity) is turned into a latent “resist image” by absorption of incident energy, which is further modified by diffusion processes and various loading effects. Efficient simulation methods that are fast enough for full-chip applications approximate the realistic 3-dimensional intensity distribution in the resist stack by a 3-dimensional aerial (and resist) image.

In an embodiment, the resist image 350 can be used an input to a post-pattern transfer process model module 360. The post-pattern transfer process model module 360 defines performance of one or more post-resist development processes (e.g., etch, development, etc.).

Simulation of the patterning process can, for example, predict contours, CDs, edge placement (e.g., edge placement error), etc. in the resist and/or etched image. Thus, the objective of the simulation is to accurately predict, for example, edge placement, and/or aerial image intensity slope, and/or CD, etc. of the printed pattern. These values can be compared against an intended design to, e.g., correct the patterning process, identify where a defect is predicted to occur, etc. The intended design is generally defined as a pre-OPC design layout which can be provided in a standardized digital file format such as GDSII or OASIS or other file format.

Thus, the model formulation describes most, if not all, of the known physics and chemistry of the overall process, and each of the model parameters desirably corresponds to a distinct physical or chemical effect. The model formulation thus sets an upper bound on how well the model can be used to simulate the overall manufacturing process.

The following paragraphs describe a system and a method for simulating stochastic effects in a lithography process using a Poisson distribution, such as photon probability distribution (PD) across a pattern area. An image representation of a pattern (e.g., an aerial image, a resist image or an etch image) may be used to evaluate a “tone-flipping” probability, which is indicative of a probability of a resist remaining in a location where it is supposed to be removed (e.g., pinching) or a probability of resist being removed where it is supposed to remain (e.g., bridging) due to shot noise or other factors that may cause stochastic effects. A failure probability map that is indicative of a tone-flipping probability (e.g., pinching or bridging probability) at any location of a pattern at a full-chip level may be generated.

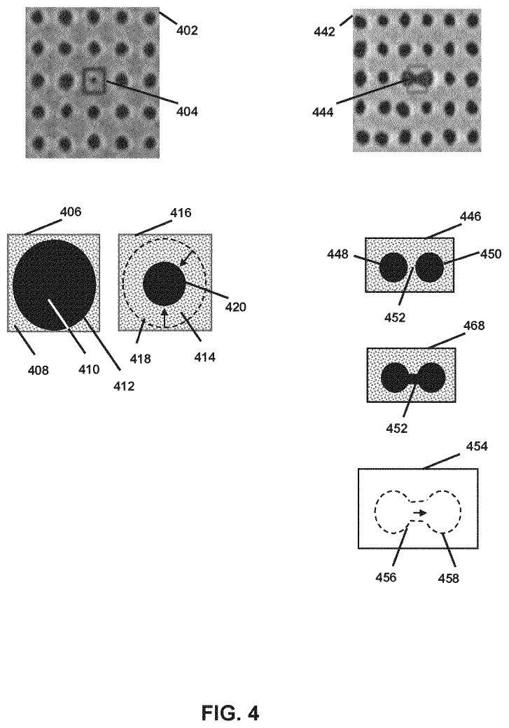

FIG. 4 is an illustration of pinching and bridging of features in a lithography process, consistent with various. A first image 402 representative of a pattern area illustrates the occurrence of pinching at a first location 404, and a second image 442 representative of a pattern area illustrates the occurrence of bridging at a second location 444. In some embodiments, the first image 402 and the second image 442 are after-development images. The pinching or bridging may cause a failure in the IC being manufactured. In some embodiments, pinching occurs when a resist remains at a location where it is supposed to be removed. For example, the image 406 shows a contact hole 412 printed on the substrate without stochastic effects. A first area 410 (e.g., area shaded in black) within the contact hole 412 is developed and the resist is removed from the first area 410. A second area 408 surrounding the contact hole 412 is not developed and the resist remains in the second area 408. When pinching occurs (e.g., due to stochastic effects) the area 414, which is supposed to be developed, may not be developed and therefore, the resist remains in the area 414 causing the contact hole 412 to shrink and print as contact hole 420, as illustrated in image 416. The pinching may cause a shift in the placement of an edge of a pattern towards the center of the pattern. For example, the edge 418 of the contact hole 412 may shift towards a center of the contact hole 420 due to pinching, as illustrated in the image 416. In some embodiments, a probability of occurrence of pinching at a particular location is indicative of a probability of edge placement at the particular location.

In some embodiments, bridging occurs when a resist is removed at a location where it is supposed to remain. For example, the image 446 shows a pair of contact holes 448 and 450 printed on the substrate without stochastic effects. The area 452 (e.g., area between the contact holes) is not developed and the resist remains in the area 452. The areas within the contact holes 448 and 450 is developed and therefore, the resist is removed from those areas. When bridging occurs (e.g., due to stochastic effects) the area 452, which is not supposed to be developed, may be developed and therefore, the resist is removed from the area 452 causing the pair of contact holes 448 and 450 to come in contact with each other, as illustrated in image 468. The bridging may cause a shift in the placement of an edge of a pattern away from the center of the pattern. For example, the edge 456 of the contact hole 448 may shift away from the center of the contact hole 448 (or the edge 458 of the contact hole 450 may shift away from the center of the contact hole 450) and merge with a neighboring contact hole 458, as illustrated in the image 454. In some embodiments, a probability of occurrence of bridging at a particular location is indicative of a probability of edge placement at the particular location. Further, the tone-flipping probability is indicative of both types of failures in an aggregated manner.

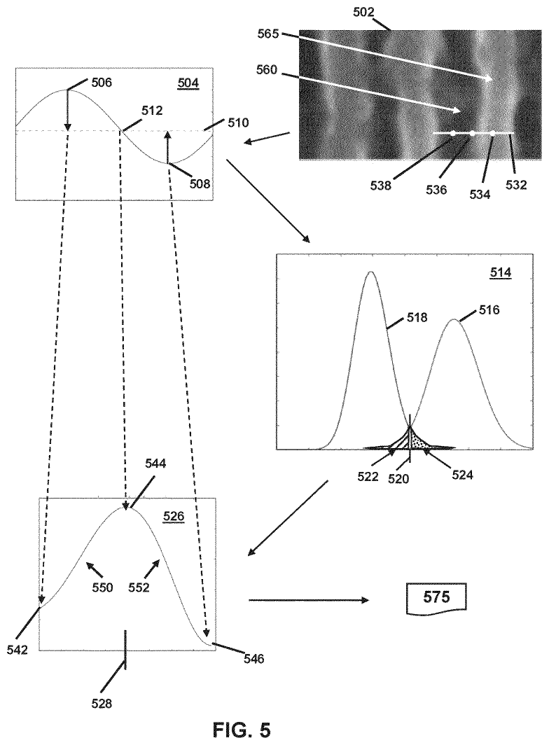

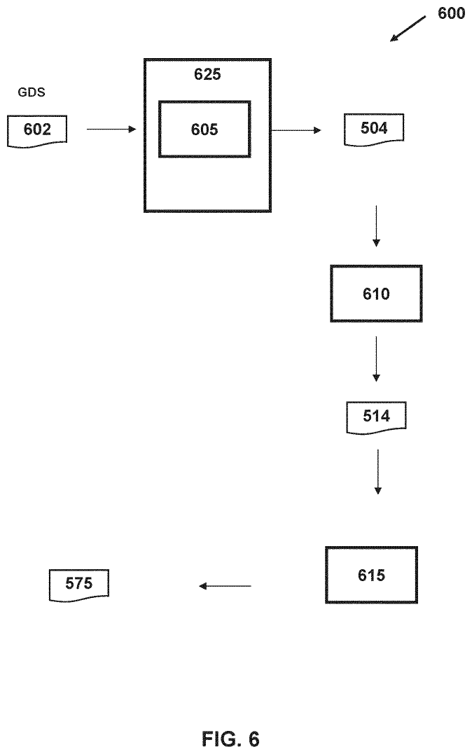

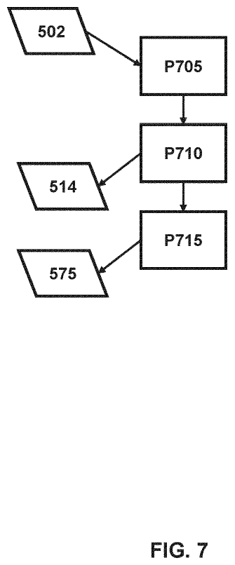

A failure probability map that is indicative of the tone-flipping probability may be determined or predicted based on photon probability distribution (PD) at each location across a pattern area, as illustrated in FIG. 5. FIG. 5 shows simulation of failure probability of a pattern area based on photon PD across the pattern area, consistent with various embodiments. An image intensity signal 504 (e.g., pixel values) is obtained across a measurement area (e.g., along cut line or line profile 532) of a pattern image 502. The image intensity signal 504 shown in FIG. 5 is for a single pitch of the pattern area, which includes pattern 560 (e.g., line pattern) and resist mask 565 (e.g., undeveloped area of the substrate where the resist remains). The pattern image 502 may be an image representation of a pattern area, such as a resist image. In other embodiments, the image representation may be an aerial image or an etch image. A photon PD is determined for each of the locations in the pattern image 502 across the line profile 532 based on the image signal at the corresponding location. For example, the photon PD at a location corresponding to a positive peak 506 (e.g., pattern center location 538, which is a location of a center of the pattern 560 on the line profile 532) is determined as a first photon PD 516, and the photon PD at a location corresponding to the negative peak 508 (e.g., resist mask center location 534, which is a location of a center of the resist mask 565 on the line profile 532) is determined as a second photon PD 518, as illustrated in photon PD graph 514. In some embodiments, the photon PD is in the form of a Poisson distribution. The x-axis of the photon PD graph 514 may represent the number of photons and the y-axis may represent the probability. Additional details of determining the photon PD is discussed at least with reference to FIGS. 6 and 7 below. By using Poisson distribution to determine the failure probability at any desired area in the pattern at the full-chip level, the disclosed embodiments enable a more accurate determination of the failure probability for any type of CD variations (e.g., not just Gaussian distribution). For example, the Poisson distribution enables accurate determination of CD variations beyond 2 or 30, which the models based on Gaussian distribution may be unable to predict or predict inaccurately.

In some embodiments, a failure probability at a particular location of the pattern area is representative of a tone-flipping probability at the particular location (e.g., a probability of pinching or bridging at the particular location), which may be determined based on the photon PD at the particular location and a photon threshold number 520. The photon threshold number is derived from an image intensity threshold 510 (e.g., using Eq. (1)). The image intensity threshold 510 is an intensity threshold level above which a resist is developed. In some embodiments, pinching may occur when a positive portion of the image intensity signal (e.g., a portion of the image intensity signal above image intensity threshold) drops below the image intensity threshold, and bridging may occur when a negative portion of the image intensity signal (e.g., a portion of the image intensity signal below the image intensity threshold) exceeds the image intensity threshold. Accordingly, the probability of pinching, which is the probability of a positive peak 506 of the image intensity signal 504 falling below the image intensity threshold 510, is determined as a probability of the number of photons from the first photon PD 516 dropping below the photon threshold number 520. In some embodiments, the probability of pinching is determined by integrating a first portion 522 of the first photon PD 516. The probability of bridging, which is the probability of a negative peak 508 of the image intensity signal 504 exceeding the image intensity threshold 510 is determined as a probability of the number of photons of the second photon PD 518 exceeding the photon threshold number 520. In some embodiments, the probability of bridging is determined by integrating a second portion 524 of the second photon PD 518.

In some embodiments, a failure probability is indicative of a tone-flipping probability at a particular location (e.g., a probability of pinching or bridging at the particular location), and a failure probability map or graph that is indicative of failure probabilities across all or some locations of the pattern area may be generated based on the tone-flipping probabilities at those locations. For example, a failure probability graph 526 may be determined based on the probabilities of pinching or bridging across all locations of the line profile 532. For example, the failure probability graph 526 shows (a) a first probability value 542, which is indicative of a probability of occurrence of pinching at a location of the pattern image 502 corresponding to the positive peak 506, (b) a second probability value 544, which is indicative of an occurrence of pinching or bridging at a location of the pattern image 502 corresponding to the image intensity signal 504 being equal to the image intensity threshold 510, and (a) a third probability value 546, which is indicative of an occurrence of bridging at a location of the pattern image 502 corresponding to the negative peak 508. The second probability value 544, which is the probability of pinching or bridging occurring on the pattern image 502 where the image intensity signal 504 is equal to the image intensity threshold 510 (e.g., location 512 in the image intensity signal 504, which corresponds to a nominal location 536 of the edge of the pattern 560 on the line profile 532 (e.g., a location of an edge of the pattern based on a nominal CD of the pattern 560), is the highest among the probabilities of the pinching or bridging occurring at all other locations of the line profile 532.

Since the failure probability graph 526 is indicative of both pinching and bridging probabilities, it may also be referred to as a “tone-flipping” graph. For example, a first portion 550 of the tone-flipping graph 526 (e.g., probability values between the first probability value 542 and the second probability value 544) is indicative of probabilities of occurrence of pinching as the first portion 550 corresponds to probabilities of the positive portion of the image intensity signal 504 dropping below the image intensity threshold 510. Similarly, a second portion 552 of the tone-flipping graph 526 (e.g., probability values between the second probability value 544 and the third probability value 546) is indicative of probabilities of occurrence of bridging as the second portion 552 corresponds to probabilities of the negative portion of the image intensity signal 504 exceeding the image intensity threshold 510.

As discussed above, pinching or bridging can result in the placement of an edge of a pattern to shift (e.g., from a nominal location corresponding to a nominal CD), and hence, may result in causing a failure in the pattern area. The probability of an edge placement (EP) of an edge of a pattern at a particular location can be determined based on, or indicated using, the probability of pinching or bridging at the particular location. In some embodiments, pinching results in a negative shift of the edge of a pattern 560, and bridging results in a positive shift of the edge. For example, the pinching results in the edge shifting from the nominal location 536 (which corresponds to nominal CD of the pattern 560) towards the center of the pattern 560 (e.g., pattern center location 538). The bridging results in the edge shifting away from the center of pattern 560—from the nominal location 536 towards the center of the resist mask 565 (e.g., resist mask center location 534). The failure probability graph 526 is indicative of the EP probability at various locations in the pattern image 502 relative to the nominal location 536. For example, the first portion 550 of the failure probability graph 526 is indicative of the EP probability of the edge of the pattern 560 at various locations between the nominal location 536 of the edge and the pattern center location 538. Similarly, the second portion 552 of the failure probability graph 526 is indicative of the EP probability of the edge of the pattern 560 at various locations between the nominal location 536 of the edge and the resist mask center location 534. In some embodiments, the x-axis of the failure probability graph 526 may be indicative of a distance along x-direction, with the origin 528 corresponding to the nominal location 536 of the edge, the left end of the x-axis corresponding to the pattern center location 538 and the right end of the x-axis corresponding to the resist mask center location 534. The y-axis may represent the EP probability value.

While the failure probability graph 526 shows the failure probability for a particular region of the pattern area (e.g., for locations on the line profile 532), the failure probability may be calculated for multiple locations of the pattern image 502 (e.g., all locations of the pattern at a full-chip level). A continuous failure probability map 575, which is indicative of a failure probability at any location of the pattern at a full-chip level may be generated. For example, the failure probability map 575 may be a pixel-based image in which each pixel corresponds to a particular location of the pattern at the full-chip level and the pixel value indicates a failure probability at the corresponding location of the pattern at the full-chip level. Additional details of generating the failure probability map 575 based on an image representation of a pattern is described at least with reference to FIGS. 6 and 7 below.

FIG. 6 is a block diagram of an exemplary system 600 for simulating stochastic effects based on an image representation of a pattern, consistent with various embodiments. FIG. 7 is a flow diagram of an exemplary method for simulating stochastic effects based on an image representation of a pattern, consistent with various embodiments.

At process P705 of FIG. 7, an image representation of a pattern area may be obtained. The image of the pattern area (e.g., pattern image 502) may be an aerial image, a resist image or an etch image. In some embodiments, an imaging model 605 such as a source model 300, a resist model 340 or a post-pattern transfer process model module 360 (e.g., etch model) of FIG. 3 associated with a lithography process may be used to generate the pattern image 502. For example, the pattern image 502 is a resist image generated using the resist model 340.

In some embodiments, the imaging model 605 may be part of a lithography model 625 that simulates the lithography process of FIG. 3. A target pattern 602 (e.g., GDS design layout) may be input to the lithography model 625, which generates the pattern image 502 using the imaging model 605. The imaging model 605 may further be configured to extract image intensity signal 504 (e.g., pixel values) from the pattern image 502 at a particular region (e.g., along the line profile 532 of FIG. 5).

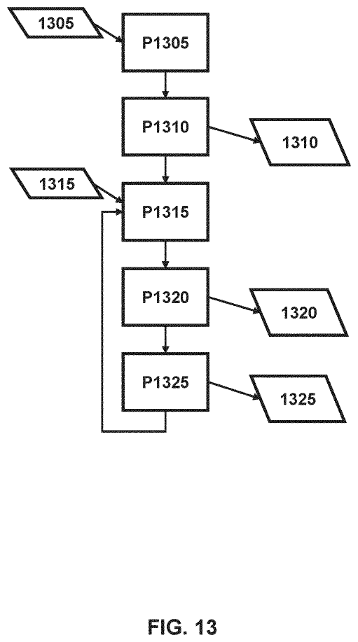

In some embodiments, the imaging model 605 may be calibrated to generate the pattern image 502. For example, substrate measurement data having multiple images of a pattern (e.g., SEM images) captured at different locations on one or more substrates is obtained and the associated failure probability data (e.g., a failure probability at any location on a pattern image) is determined by processing the images of the pattern. The failure probability data is then used to calibrate the imaging model 605 to generate the pattern image 502. Additional details of calibrating the imaging model 605 is described at least with reference to FIG. 13.

At process P710, a photon PD component 610 determines a photon PD at each location of the pattern area based on the image intensity signal at the corresponding location. For example, the photon PD component 610 determines the first photon PD 516 in the pattern image 502 at a location corresponding to a positive peak 506, and the second photon PD 518 at a location corresponding to the negative peak 508, as illustrated in photon PD graph 514. In some embodiments, the photon PD component 610 determines the first photon PD 516 based on the value of the image intensity signal 504 at positive peak 506, and the second photon PD 518 based on the value of the image intensity signal 504 at the negative peak 508.

In some embodiments, the photon PD is in the form of a Poisson distribution. The photon PD may be derived from the image intensity signal based on the formula as follows:

$$f ( k , λ ) = Pr ( X = k ) = {λ}^{k} {e}^{- λ} / k ! \qquad Eq . ( 1 )$$

where k is the number of photons, A is the variance of the number of photons, X is the same as k, e is Euler's number, and ! is factorial.

At process P715, a failure probability component 615 determines a failure probability map of an after-development image of the pattern area (e.g., resist image) based on the photon PD. In some embodiments, the failure probability map 575 is a continuous map that enables determination of a failure probability (e.g., tone-flipping probability or EP probability) at any location of the pattern area. The tone-flipping probability is a probability of occurrence of pinching or bridging at a particular location of the pattern area. As described at least with reference to FIG. 5, in some embodiments, pinching occurs when a positive portion of the image intensity signal 504 drops below the image intensity threshold 510 and a probability of such an occurrence is determined based on a probability of the number of photons corresponding to the positive portion of the image intensity signal 504 dropping below the photon threshold number 520. For example, the probability of pinching at the pattern center location 538, which corresponds to the probability of a positive peak 506 of the image intensity signal 504 falling below the image intensity threshold 510, is determined as a probability of the number of photons from the first photon PD 516 dropping below the photon threshold number 520. The probability of the number of photons dropping below the photon threshold number 520 may be determined by integrating a first portion 522 of the first photon PD 516. In some embodiments, the photon threshold number 520 is determined based on the image intensity threshold 510 by a calibrated coefficient.

Similarly, bridging occurs when a negative portion of the image intensity signal 504 exceeds the image intensity threshold 510 and a probability of such an occurrence is determined based on a probability of the number of photons corresponding to the negative portion of the image intensity signal 504 exceeding the photon threshold number 520. For example, the probability of bridging at the resist mask center location 534, which is the probability of a negative peak 508 of the image intensity signal 504 exceeding the image intensity threshold 510 is determined as a probability of the number of photons of the second photon PD 518 exceeding the photon threshold number 520. The probability of the number of photons exceeding the photon threshold number 520 may be determined by integrating a second portion 524 of the second photon PD 518.

Such probabilities of pinching or bridging is obtained for various locations in particular region (e.g., along the line profile 532) and a failure probability graph 526 is generated, as illustrated in FIG. 5. While the failure probability graph 526 shows the failure probability for a particular region (e.g., locations of the line profile 532), the failure probability may be calculated for multiple locations of the pattern image 502 (e.g., all locations of the pattern at a full-chip level), and a continuous failure probability map 575, which is indicative of a failure probability at any location of the pattern at a full-chip level may be generated. For example, the failure probability map 575 may be a pixel-based image in which each pixel corresponds to a particular location of the pattern at the full-chip level and the pixel value indicates a failure probability at the corresponding location of the pattern at the full-chip level.

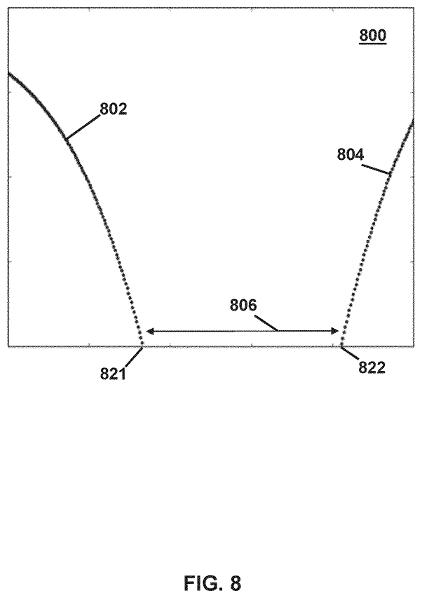

FIG. 8 is a graph illustrating modelling of mean CD of a pattern based on the simulation of stochastic effects, consistent with various embodiments. In some embodiments, the method of FIG. 7 may be used to determine a range of mean CD values for a pattern (e.g., pattern 560) to minimize the failure probabilities. In the mean CD-failure probability graph 800, the x-axis indicates mean CD value, and the y-axis indicates probability values. The graph 800 shows (a) a first failure probability graph 802 that indicates probabilities of pinching for various mean CD values of the pattern 560, and (b) a second failure probability graph 804 that indicates probabilities of bridging for various mean CD values of the pattern 560. The failure (e.g., pinching or bridging) probability values are determined for different mean CD values by varying the dose value. For example, a first pattern image may be simulated for a first dose value and the failure probability values obtained using the image intensity signal derived from the first pattern image correspond to a first mean CD value of a pattern. Similarly, a second pattern image may be simulated for a second dose value and the failure probability values obtained using the image intensity signal derived from the second pattern image correspond to a second mean CD value of the pattern. In some embodiments, the failure probability values for each dose value may be obtained for a positive peak and a negative peak of the image intensity signal. The failure probability values may be obtained for various mean CD values, and the mean CD-failure probability graph 800 may be generated using those failure probability values.

As illustrated in the graph 800, the pinching probability starts at a first mean CD value 821 and increases as the mean CD decreases. Similarly, the bridging probability starts at a second mean CD value 822 and increases as the mean CD increases. Accordingly, the mean CD of a pattern may be determined to be in a range 806 to minimize the failure probabilities due to stochastic effects, as illustrated in the graph 800.

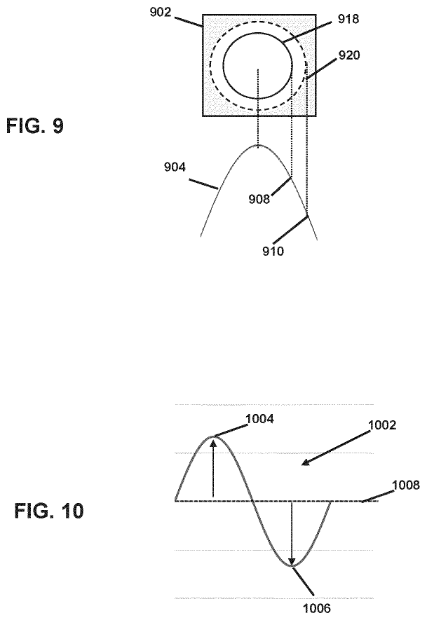

FIG. 9 illustrates another application of simulation of stochastic effects using an image representation of a pattern, consistent with various embodiments. In some embodiments, the method of FIG. 7 may be used to determine a failure probability at any specification (e.g., CD) of a pattern using an image representation of the pattern. For example, consider that a pattern image 902 includes a feature such as a contact hole 918 with a first specification (e.g., a first CD value). An image intensity signal 904 may be derived from the pattern image 902 for various specifications of the pattern. For example, the image intensity signal 904 has an image intensity signal value 908 for a location corresponding to the first specification, and an image intensity signal value 910 for a location corresponding to a second specification 920 of the contact hole 918 (e.g., a second CD value greater than the first CD value). The failure probability values (e.g., pinching or bridging) may be calculated for the second specification 920 by obtaining the image intensity signal value 910 at the location corresponding to the second specification 920 and calculating the failure probability based on the image intensity signal value 910, as described at least with reference to FIGS. 6 and 7 above.

In some embodiments, the method of FIG. 7 may also be used to search for a region in a pattern that has a failure probability above a specified probability value. A specified image intensity signal that may be needed for causing a failure at the specified failure probability value is determined, and then the pattern image 902 is searched for an area having an image intensity signal (a) greater than the specified image intensity signal for pinching, or (b) lesser than the specified image intensity signal for bridging.

In some embodiments, the image intensity signal corresponding to a particular failure probability is determined based on the photon PD. For example, as described at least with reference to FIGS. 5-7, a failure probability value (e.g., pinching or bridging) is determined from photon PD, which is determined from the image intensity signal derived from a pattern image. Accordingly, in order to determine the required image intensity signal for achieving a particular failure probability value, a photon PD is obtained based on the particular failure probability value and the required image intensity signal is based on the photon PD (e.g., using Eq. (1)).

In some embodiments, the above method of determining failure probabilities may also be used in optimizing source or mask variables in a lithography process for printing a pattern on a substrate. FIG. 10 illustrates an application of simulation of stochastic effects using an image representation of a pattern for a source mask optimization (SMO), consistent with various embodiments. In some embodiments, the method of FIG. 7 may also be used for an SMO process, which optimizes source or mask variables in printing a pattern on a substrate. The SMO process may use the image intensity signal 1002 derived from a pattern image that is representative of a pattern to be printed on a substrate to optimize the source or mask variables. For example, the source or mask variables may be optimized to maximize Rₘₐₓ−Rₜₕ and Rₜₕ−Rₘᵢₙ, where Rₘₐₓ is positive peak value 1004, Rₘᵢₙ is negative peak value 1006 and Rₜₕ is image intensity threshold value 1008. The failure probabilities are calculated for each of Rₘₐₓ and Rₘᵢₙ value pair, and the Rₘₐₓ−Rₜₕ and Rₜₕ−Rₘᵢₙ values may be maximized until the corresponding failure probabilities are minimized at which point the source or mask variables are optimized.

The following paragraphs describe determining stochastic variation in a pattern using metrology data. In some embodiments, stochastic variation in a pattern may be determined based on pixel intensity distribution across several images of a pattern printed on a substrate. Several images of the pattern (e.g., SEM images) are obtained and grouped based on a grouping parameter (e.g., optical equivalence) to obtain a set of images. The set of images are aligned (e.g., with a target pattern) and processed to remove noise and distortion. Pixel intensity distribution is determined for each location of the pattern across the set of images and a failure probability map, or a stochastic failure map is generated therefrom.

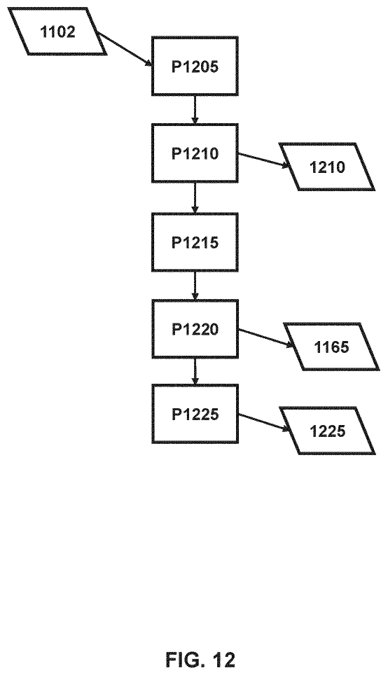

FIG. 11 is a block diagram of an exemplary system for determining stochastic variation in a pattern based on pixel intensity distribution, consistent with various embodiments. FIG. 12 is a flow diagram of a method for determining stochastic variation in a pattern based on pixel intensity distribution, consistent with various embodiments. At process P1205, several images 1102 of a pattern printed on a substrate are obtained. The images 1102 may be captured using a metrology tool (e.g., SEM). In some embodiments, images 1102 may be images of the pattern captured at different locations of the substrate. For example, an image 1102a of the pattern may be captured in a first location of the substrate (e.g., a first die) and an image 1102b may be captured from a second location of the substrate (e.g., a second die). At process P1210, the images 1102 are grouped based on a grouping parameter (e.g., optical equivalence) to obtain a set of images 1210. In some embodiments, two images of a pattern at different locations of a substrate are considered to be optically equivalent if their optical proximity effects are the same. In some embodiments, optical proximity effects are the variations in the linewidth of a feature (or the shape for a 2D pattern) as a function of the proximity of other nearby features. In some embodiments, the optical proximity effect refers to the ability to print a given feature as influenced by the proximity of other nearby features on a particular substrate. For example, the width of a small isolated feature may be different than width of the same feature in an array of such features, even if the mask shapes/widths are the same. In some embodiments, the images that are not optically equivalent may not be considered (e.g., excluded from the set of images 1210).

At process P1215, the set of images 1210 are aligned (e.g., with a target pattern such as a GDS design layout). In some embodiments, the aligned images are processed to remove noise and distortion.

At process P1220, a pixel intensity distribution component 1105 generates a pixel intensity distribution of each location in the pattern from the set of images 1210. For example, the pixel intensity distribution component 1105 generates a pixel intensity distribution 1165 for a first location of the pattern by obtaining a pixel value of the corresponding pixel from each image of the set of images 1210, as illustrated in pixel intensity graph 1150. In some embodiments, the x-axis of the pixel intensity graph 1150 is pixel intensity value and the y-axis is the count of pixels.

At process P1225, a stochastic error image component 1110 generates one or more images 1225 that are indicative of stochastic errors (e.g., stochastic edge placement error (SEPE), σ_{EPE}) or failure probability values (e.g., pinching or bridging probability values). In some embodiments, the stochastic errors are determined based on a statistic variance of the pixel intensity distribution of each pixel. The stochastic error image component 1110 may determine one or more parameters from the pixel intensity distribution 1165 that enables determination of the σ_{EPE} or the failure probabilities. For example, the stochastic error image component 1110 may determine a standard deviation, σ, of the pixel intensity values based on the pixel intensity distribution 1165. In some embodiments, the standard deviation, σ, is indicative of the σ_{EPE}. Note that the pixel intensity distribution 1165 is for a single location of a pattern. The pixel intensity distribution may be similarly obtained for multiple locations of a pattern (e.g., for all locations of the pattern at a full-chip level) and the σ_{EPE} may be calculated for each of those locations based on the pixel intensity distribution corresponding to that location. An image having the σ_{EPE} values for each of those locations may be generated. For example, the stochastic error image component 1110 may generate a standard deviation image 1112 in which each pixel has a value that is indicative of σ_{EPE} 1124 at the corresponding location in the pattern.

Similarly, in some embodiments, the stochastic error image component 1110 may generate a slope image in which each pixel has a value that is indicative of a slope 1164 of the pixel intensity distribution at the corresponding location in the pattern. In some embodiments, the σ_{EPE} 1124 may be derived from the slope 1164 of the pixel intensity distribution.

In yet another embodiment, the stochastic error image component 1110 may generate a full width at half maximum (FWHM) image 1114 in which each pixel has a value that is indicative of FWHM of the pixel intensity distribution at the corresponding location in the pattern. In some embodiments, the maximum 1158 in the pixel intensity distribution is the maximum number of pixels having the same pixel intensity, and half maximum 1160 is half of the maximum 1158. The FWHM value 1152 is determined as a difference between the pixel intensities at half maximum 1160 of the pixel intensity distribution. For example, the FWHM value 1152 is determined as a difference between a first pixel intensity at location 1168 and a second pixel intensity at location 1166. In some embodiments, the σ_{EPE} 1124 may be derived from the FWHM value of the pixel intensity distribution. In some embodiments, the FWHM is defined as follows:

$$FWHM = 2.355 σ \qquad Eq . ( 2 )$$

Accordingly, the σ may be calculated as:

$$σ = FWHM / 2.355 \qquad Eq . ( 3 )$$

In some embodiments, the stochastic error image component 1110 may generate a failure probability image 1116 in which each pixel has a value that is indicative of a failure probability 1120 at the corresponding location in the pattern. In some embodiments, the failure probability value 1120 may be derived from the pixel intensity distribution 1165. A first portion 1154, A_{P}, of the pixel intensity distribution 1165 below a first pixel intensity threshold (e.g., for pinching) and a second portion 1156, A_{B}, of the pixel intensity distribution 1165 above a second pixel intensity threshold (e.g., for bridging) are identified. A failure probability value is determined based on the whole area of pixel intensity distribution 1165, the first portion 1154, A_{P}, and the second portion 1156, A_{B}. For example, the failure probability may be represented as:

$$FP = ( {A}_{P} + {A}_{B} ) / A \qquad Eq . ( 4 )$$

where A_{P} is the portion of the pixel intensity distribution below a first pixel intensity threshold for pinching, A_{B} is the portion of the pixel intensity distribution above a second pixel intensity threshold for bridging, and A is the entire area of the pixel intensity distribution. In some embodiments, the failure probability image 1116 is similar to the failure probability map 575 of FIG. 5.

The following paragraphs describe calibrating a lithographic model (e.g., the imaging model 605) to generate an image of the pattern (e.g., pattern image 502) that is used in simulating the stochastic effects as described above at least with reference to FIGS. 5-7. In some embodiments, the calibration is performed using the failure probability image 1116 determined using metrology data (e.g., as described at least with reference to FIG. 12 above).

FIG. 13 is a flow diagram of a method for calibrating a lithographic model to generate an image representation of a pattern, consistent with various embodiments. As described at least with reference to FIGS. 6 and 7, an image representation of a pattern, e.g., pattern image 502, that is used in deriving a failure probability map 575, may be at least one of an aerial image, a resist image or an etch image. The imaging model 605 may be calibrated to generate the pattern image 502. Note that following paragraphs describe calibrating the imaging model 605 such as a resist model to generate a resist image. However, the calibration method may be implemented for calibrating the imaging model 605 to generate other types of images of the pattern, such as an aerial image or etch image, as well.

At process P1305, substrate measurement data 1305 may be obtained. In some embodiments, the substrate measurement data 1305 may include the failure probability image 1116 that is derived from processing multiple images of a pattern printed on a substrate (e.g., SEM images), as described at least with reference to FIGS. 11 and 12. The failure probability image 1116 is indicative of a failure probability at each location of a pattern printed on the substrate. The substrate measurement data 1305 may also include other data such as several images of the pattern printed on the substrate, SEPE data (e.g., standard deviation image 1112 having SEPE data), or other such data.

At process P1310, a specified failure probability value 1310 and its corresponding location in the pattern is obtained from the failure probability image 1116. In some embodiments, the corresponding location may be determined as the EP position of an edge of the pattern from the nominal location of the edge, as described at least with reference to FIG. 5. For example, a specified failure probability value 1310, fp=0.003, may be obtained at “−2.5 nm” from a resist contour (or the nominal location of the edge). In some embodiments, the failure probability value may be obtained at multiple locations, such as pattern center, 3σ, etc. In some embodiments, the substrate measurement data at different dose values may also be used to minimize requirement of SEPE data.

At process P1315, the values of imaging model parameters 1315 are set. For example, if the imaging model 605 is a resist model, then values of the non-linear imaging model parameters 1315 such as focus, dose, diffusion (aiBlur), sigma (diffusion lengths) and other physical terms associated with a resist are set.

At process P1320, a photon PD is obtained from the substrate measurement data 1305 at the location corresponding to the specified failure probability value 1310, and a specified image intensity value 1320 required to achieve the specified failure probability value 1310 is determined from the photon PD.

At process P1325, the coefficients 1325 of the imaging model parameters are determined based on the specified image intensity value 1320, and aerial image intensity value (e.g., obtained from the substrate measurement data 1305). In some embodiments, the specified image intensity value may be expressed a linear equation as follows:

$$R = \sum {C}_{i} {A}_{i} - TH \qquad Eq . ( 5 )$$

where R is image intensity signal (e.g., resist image intensity), Cᵢ is i^{th} co-efficient, Aᵢ is aerial image intensity, and TH is image intensity threshold (e.g., resist image intensity threshold—a threshold above which a resist is developed).

The above equation is solved to obtain the coefficients 1325 of the imaging model 605. In some embodiments, after determining the coefficients 1325, it is determined whether a cost function is minimized. In some embodiments, the cost function is indicative of a difference between the image intensity value computed in the process P1325 and the actual image intensity value obtained by Poisson statistics based on the failure probability determined from the measurement data. If the cost function is not minimized, the values of the imaging model parameters 1315 are adjusted, the specified image intensity value 1320 is recomputed, and equation 5 is solved to determine the coefficients. The processes P1315-P1325 are repeated until the cost function is minimized. After the cost function is minimized, the coefficient values are finalized and the imaging model 605 is considered to be calibrated and may be used to generate an image of a pattern (e.g., pattern image 502 described at least with reference to FIGS. 6 and 7), which may be used in determining a failure probability map (e.g., failure probability map 575) that is indicative of a tone-flipping probability, as described at least with reference to FIGS. 5-7.

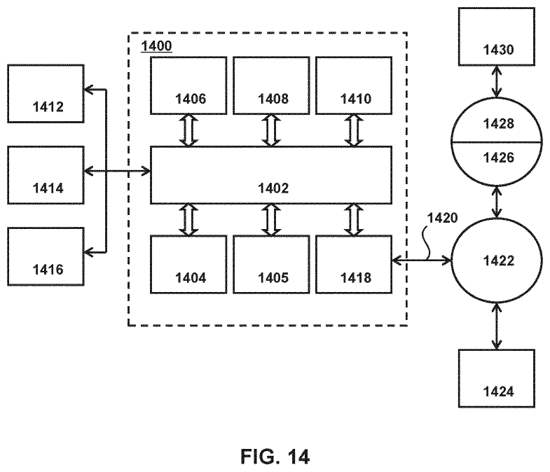

FIG. 14 is a block diagram that illustrates a computer system 1400 which can assist in implementing various methods and systems disclosed herein. The computer system 1400 may be used to implement any of the entities, components, modules, or services depicted in the examples of the figures (and any other entities, components, modules, or services described in this specification). The computer system 1400 may be programmed to execute computer program instructions to perform functions, methods, flows, or services (e.g., of any of the entities, components, or modules) described herein. The computer system 1400 may be programmed to execute computer program instructions by at least one of software, hardware, or firmware.

Computer system 1400 includes a bus 1402 or other communication mechanism for communicating information, and a processor 1404 (or multiple processors 1404 and 1405) coupled with bus 1402 for processing information. Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT) or flat panel or touch panel display for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane. A touch panel (screen) display may also be used as an input device.

According to one embodiment, portions of one or more methods described herein may be performed by computer system 1400 in response to processor 1404 executing one or more sequences of one or more instructions contained in main memory 1406. Such instructions may be read into main memory 1406 from another computer-readable medium, such as storage device 1410. Execution of the sequences of instructions contained in main memory 1406 causes processor 1404 to perform the process steps described herein. One or more processors in a multi-processing arrangement may also be employed to execute the sequences of instructions contained in main memory 1406. In an alternative embodiment, hard-wired circuitry may be used in place of or in combination with software instructions. Thus, the description herein is not limited to any specific combination of hardware circuitry and software.

The term “computer-readable medium” as used herein refers to any medium that participates in providing instructions to processor 1404 for execution. Such a medium may take many forms, including but not limited to, non-volatile media, volatile media, and transmission media. Non-volatile media include, for example, optical or magnetic disks, such as storage device 1410. Volatile media include dynamic memory, such as main memory 1406. Transmission media include coaxial cables, copper wire and fiber optics, including the wires that comprise bus 1402. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1404 for execution. For example, the instructions may initially be borne on a magnetic disk of a remote computer. The remote computer can load the instructions into its dynamic memory and send the instructions over a telephone line using a modem. A modem local to computer system 1400 can receive the data on the telephone line and use an infrared transmitter to convert the data to an infrared signal. An infrared detector coupled to bus 1402 can receive the data carried in the infrared signal and place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also preferably includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the worldwide packet data communication network, now commonly referred to as the “Internet” 1428. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are exemplary forms of carrier waves transporting the information.

Computer system 1400 can send messages and receive data, including program code, through the network(s), network link 1420, and communication interface 1418. In the Internet example, a server 1430 might transmit a requested code for an application program through Internet 1428, ISP 1426, local network 1422 and communication interface 1418. One such downloaded application may provide for the illumination optimization of the embodiment, for example. The received code may be executed by processor 1404 as it is received, or stored in storage device 1410, or other non-volatile storage for later execution. In this manner, computer system 1400 may obtain application code in the form of a carrier wave.

While the concepts disclosed herein may be used for imaging on a substrate such as a silicon wafer, it shall be understood that the disclosed concepts may be used with any type of lithographic imaging systems, e.g., those used for imaging on substrates other than silicon wafers.

The terms “optimizing” and “optimization” as used herein refers to or means adjusting a patterning apparatus (e.g., a lithography apparatus), a patterning process, etc. such that results and/or processes have more desirable characteristics, such as higher accuracy of projection of a design pattern on a substrate, a larger process window, etc. Thus, the term “optimizing” and “optimization” as used herein refers to or means a process that identifies one or more values for one or more parameters that provide an improvement, e.g., a local optimum, in at least one relevant metric, compared to an initial set of one or more values for those one or more parameters. “Optimum” and other related terms should be construed accordingly. In an embodiment, optimization steps can be applied iteratively to provide further improvements in one or more metrics.

Aspects of the invention can be implemented in any convenient form. For example, an embodiment may be implemented by one or more appropriate computer programs which may be carried on an appropriate carrier medium which may be a tangible carrier medium (e.g., a disk) or an intangible carrier medium (e.g., a communications signal). Embodiments of the invention may be implemented using suitable apparatus which may specifically take the form of a programmable computer running a computer program arranged to implement a method as described herein. Thus, embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Embodiments of the present disclosure can be further described by the following clauses.
1. A method for simulating stochastic effect in a lithography process, the method comprising: obtaining an image of a pattern area;
   determining photon probability distribution (PD) at each location of the pattern area based on image intensity at the corresponding location; and
   determining a failure probability map of an after-development image of the pattern area based on the photon PD, wherein the failure probability map is a continuous map that enables determination of a failure probability at any location of the pattern area.
2. The method of clause 1, wherein the photon PD at a particular location of the pattern area is a form of Poisson distribution.
3. The method of clause 1, wherein determining the failure probability map includes:
   determining tone-flipping probability that is indicative of a probability of an occurrence of pinching or bridging at each of the locations in the pattern area.
4. The method of clause 3, wherein the pinching occurs when a resist on a substrate remains at a location of the pattern area where the resist is configured to be removed, and wherein the bridging occurs when the resist is removed from the location of the pattern area where the resist is configured to remain.
5. The method of clause 3, wherein the probability of occurrence of pinching at a specified location in the pattern area is determined based on the image intensity dropping below a specified threshold intensity at the specified location.
6. The method of clause 5, wherein determining the probability of occurrence of pinching includes integrating an area of the photon PD corresponding to a number of photons dropping below a threshold number of photons.
7. The method of clause 6, wherein the threshold number of photons is determined based on the specified threshold intensity.
8. The method of clause 3, wherein the probability of occurrence of bridging at a specified location in the pattern area is determined based on the image intensity exceeding a specified threshold intensity at the specified location.
9. The method of clause 8, wherein determining the probability of occurrence of bridging includes integrating an area of the photon PD corresponding to a number of photons exceeding a threshold number of photons.
10. The method of clause 3, wherein the occurrence of pinching is indicative of a shift in an edge placement of an edge of a pattern towards a center of a pattern, and wherein the occurrence of bridging is indicative of a shift in the edge placement away from the center of the pattern.
11. The method of clause 3, wherein the probability of occurrence of pinching or the probability of occurrence of bridging in a specified location of the pattern area is indicative of a probability of an edge placement of an edge of a pattern in the specified location.
12. The method of clause 1, wherein the failure probability map is a pixel-based map, wherein each pixel value is indicative of the failure probability at a corresponding location in the pattern area.
13. The method of clause 1 further comprising:
   determining a mean critical dimension (CD) of a pattern to be printed on a substrate based on the failure probability map.
14. The method of clause 1 further comprising:
   searching, based on the failure probability map, for a region in the pattern area having a failure probability above a specified failure probability.
15. The method of clause 14, wherein searching for the region includes:
   determining a specified photon PD based on the specified failure probability; and
   determining a specified image intensity that corresponds to the specified photon PD.
16. The method of clause 15, wherein searching for the region includes:
   determining the region in the image of the pattern area having the image intensity greater than the specified image intensity for the failure probability corresponding to pinching.
17. The method of clause 15, wherein searching for the region includes:
   determining the region having the image intensity lesser than the specified image intensity for the failure probability corresponding to bridging.
18. The method of clause 1, wherein the image of the pattern area is at least one of an aerial image, a resist image or an etch image.
19. The method of clause 1, wherein obtaining the image includes:
   calibrating a lithography model based on substrate measurement data to generate the image of the pattern area, wherein the substrate measurement data includes a specified failure probability map indicating failure probability at each location of a specified pattern printed on a substrate.
20. The method of clause 19, wherein the lithography model includes at least one of a source model, a resist model or an etch model used in simulating the lithography process.
21. The method of clause 19, wherein calibrating the lithography model includes:
   determining a specified image intensity signal that corresponds to a particular failure probability value of the specified failure probability map at a specified edge placement position; and
   determining coefficients of parameters of the lithography model based on the specified image intensity and a specified threshold intensity.
22. The method of clause 21, wherein the lithography model is a resist model, and wherein the parameters of the resist model include physical terms associated with a resist used in the lithography process.
23. The method of clause 19, wherein calibrating the lithography model includes:
   obtaining the substrate measurement data, the substrate measurement data including multiple images of the specified pattern at different locations of the substrate;
   determining pixel intensity distribution of each location in the specified pattern from the images; and
   determining the specified failure probability map based on the pixel intensity distribution and intensity failure thresholds.
24. The method of clause 23, wherein the intensity failure thresholds are defined for tone-flip failures based on full width half maximum (FWHM) of the pixel intensity distribution.
25. The method of clause 23, wherein the intensity failure thresholds include a first intensity threshold for a failure corresponding to pinching and a second intensity threshold corresponding to bridging.
26. The method of clause 23 further comprising:
   determining stochastic errors of the specified pattern based on the pixel intensity distribution.
27. The method of clause 26, wherein the stochastic errors includes determining an image representing at least one of: standard deviation, FWHM, and slope value of the pixel intensity distribution at each location of the specified pattern based on the pixel intensity distribution.
28. The method of clause 23, wherein obtaining the images includes:
   grouping the images based on optical equivalence to obtain a set of images; and
   aligning the set of images with a target pattern.
29. The method of clause 28 further comprising:
   processing the set of images to remove noise or correction distortion.
30. The method of clause 23, wherein the images of the pattern are captured using a metrology tool.
31. The method of clause 30, wherein the metrology tool includes a scanning electron microscope.
32. A method for determining stochastic effect in a lithography process, the method comprising:
   aligning a set of images of a pattern;
   determining pixel intensity distribution of each location in the pattern from the set of images; and
   determining stochastic errors of the pattern based on the pixel intensity distribution.
33. The method of clause 32, wherein the stochastic errors are determined based on a statistic variance of the pixel intensity distribution of each pixel.
34. The method of clause 32 further comprising:
   determining a failure probability image indicating failure probability at each location of the pattern based on the pixel intensity distribution and specified intensity thresholds for failures.
35. The method of clause 34, wherein the specified intensity thresholds are defined for tone-flip failures based on full width half maximum (FWHM) of the pixel intensity distribution.
36. The method of clause 34, wherein the specified intensity thresholds include a first intensity threshold for a failure corresponding to pinching and a second intensity threshold corresponding to bridging.
37. The method of clause 32, wherein the stochastic errors includes determining an image representing at least one of: standard deviation, FWHM, and slope value of the pixel intensity distribution at each location of the pattern based on the pixel intensity distribution.
38. The method of clause 33, wherein aligning the set of images includes:
   obtaining multiple images of the pattern at different locations of a substrate;
   grouping the images based on optical equivalence to obtain the set of images; and
   aligning the set of images with a corresponding pattern in a target pattern.
39. The method of clause 38 further comprising:
   processing the set of images to remove noise or correction distortion.
40. The method of clause 32, wherein the set of images of the pattern is captured using a metrology tool.
41. The method of clause 40, wherein the metrology tool includes a scanning electron microscope.
42. The method of clause 32 further comprising:
   grouping patterns of a design layout to generate multiple groups of patterns, wherein the pattern is a representative pattern from a specified group of the groups of patterns.
43. An apparatus, the apparatus comprising:
   a memory storing a set of instructions; and
   a processor configured to execute the set of instructions to cause the apparatus to perform a method of any of the above clauses.
44. A non-transitory computer-readable medium having instructions recorded thereon, the instructions when executed by a computer implementing the method of any of the above clauses.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The reader should appreciate that the present application describes several inventions. Rather than separating those inventions into multiple isolated patent applications, these inventions have been grouped into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such inventions or all aspects of such inventions.

It should be understood that the description and the drawings are not intended to limit the present disclosure to the particular form disclosed, but to the contrary, the intention is to cover all modifications, equivalents, and alternatives falling within the spirit and scope of the inventions as defined by the appended claims.

Modifications and alternative embodiments of various aspects of the inventions will be apparent to those skilled in the art in view of this description. Accordingly, this description and the drawings are to be construed as illustrative only and are for the purpose of teaching those skilled in the art the general manner of carrying out the inventions. It is to be understood that the forms of the inventions shown and described herein are to be taken as examples of embodiments. Elements and materials may be substituted for those illustrated and described herein, parts and processes may be reversed or omitted, certain features may be utilized independently, and embodiments or features of embodiments may be combined, all as would be apparent to one skilled in the art after having the benefit of this description. Changes may be made in the elements described herein without departing from the spirit and scope of the invention as described in the following claims. Headings used herein are for organizational purposes only and are not meant to be used to limit the scope of the description.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

1. A non-transitory computer-readable medium having recorded instructions recorded, the instructions, when executed by one or more processors, are configured to cause the one or more processors to at least:
obtain an image of a pattern area;
determine a photon probability distribution (PD) at each location of the pattern area based on image intensity at the corresponding location; and
determine a failure probability map of an after-development image of the pattern area based on the photon PD, wherein the failure probability map is a continuous map that enables determination of a failure probability at any location of the pattern area.

2. The medium of claim 1, wherein the photon PD at a particular location of the pattern area is represented in form of a Poisson distribution.

3. The medium of claim 1, wherein the instruction configured to cause the one or more processors to determine the failure probability map are further configured to cause the one or more processors to determine tone-flipping probability that is indicative of a probability of an occurrence of pinching or bridging at each of the locations in the pattern area,
wherein the pinching occurs when a resist on a substrate remains at a location of the pattern area where the resist is configured to be removed,
wherein the bridging occurs when the resist is removed from the location of the pattern area where the resist is configured to remain, and
wherein the probability of occurrence of pinching or bridging at a specified location in the pattern area is determined based on comparison of the image intensity with a specified threshold intensity at the specified location.

4. The medium of claim 3, wherein the instructions are further configured to cause the one or more processors to determine the probability of occurrence of pinching, wherein the determination of the probability of occurrence of pinching comprises integration of an area of the photon PD corresponding to a number of photons and comparison of the integrated value of the number of photons with a threshold number of photons.

5. The medium of claim 3, wherein the probability of occurrence of pinching or bridging in a specified location of the pattern area is indicative of a probability of an edge placement of an edge of a pattern in the specified location.

6. The medium of claim 1, wherein the failure probability map is a pixel-based map, wherein each pixel value is indicative of the failure probability at a corresponding location in the pattern area.

7. The medium of claim 1, wherein the instructions are further configured to cause the one or more processors to determine a mean critical dimension (CD) of a pattern to be printed on a substrate based on the failure probability map.

8. The medium of claim 1, wherein the instructions are further configured to cause the one or more processors to search, based on the failure probability map, for a region in the pattern area having a failure probability above a specified failure probability,
wherein the search for the region includes:
determination of a specified photon PD based on the specified failure probability; and
determination of a specified image intensity that corresponds to the specified photon PD.

9. The medium of claim 1, wherein the image of the pattern area is at least one selected from: an aerial image, a resist image or an etch image,
wherein the instructions configured to cause the one or more processors to obtain the image are further configured to cause the one or more processors to calibrate a lithography model based on substrate measurement data to generate the image of the pattern area,
wherein the substrate measurement data includes a specified failure probability map indicating failure probability at each location of a specified pattern printed on a substrate, and
wherein the lithography model includes at least one selected from: a source model, a resist model or an etch model, used in simulating the lithography process.

10. The medium of claim 9, wherein the instruction configured to cause the one or more processors to calibrate the lithography model are further configured to cause the one or more processors to:
determine a specified image intensity signal that corresponds to a particular failure probability value of the specified failure probability map at a specified edge placement position; and
determine one or more coefficients of one or more parameters of the lithography model based on the specified image intensity and a specified threshold intensity.

11. The medium of claim 9, wherein the lithography model is a resist model, and wherein the parameters of the resist model include physical terms associated with a resist used in the lithography process.

12. The medium of claim 9, wherein the instruction configured to cause the one or more processors to calibrate the lithography model are further configured to cause the one or more processors to:
obtain the substrate measurement data, the substrate measurement data including multiple images of the specified pattern at different locations of the substrate;
determine a pixel intensity distribution of each location in the specified pattern from the images; and
determine the specified failure probability map based on the pixel intensity distribution and intensity failure thresholds.

13. The medium of claim 12, wherein the instructions are further configured to cause the one or more processors to determine stochastic errors of the specified pattern based on the pixel intensity distribution.

14. The medium of claim 13, wherein the instruction configured to cause the one or more processors to determine the stochastic errors are further configured to cause the one or more processors to determine an image representing at least one selected from: standard deviation, FWHM, and/or slope value of the pixel intensity distribution at each location of the specified pattern based on the pixel intensity distribution.

15. The medium of claim 12, wherein the instruction configured to cause the one or more processors to obtain the images are further configured to cause the one or more processors to:
group the images based on optical equivalence to obtain a set of images; and
align the set of images with a target pattern,
wherein the images of the pattern are captured using a metrology tool.

16. A non-transitory computer-readable medium having recorded instructions recorded, the instructions, when executed by one or more processors, are configured to cause the one or more processors to at least:
align a set of images of a pattern of, or for, a lithography process;
determine a pixel intensity distribution of each location in the pattern from the set of images; and
determine a stochastic error of the pattern based on the pixel intensity distribution.

17. The medium of claim 16, wherein the stochastic error is determined based on a statistic variance of the pixel intensity distribution of each pixel.

18. The medium of claim 16, wherein the instructions are further configured to cause the one or more processors to determine a failure probability image indicating failure probability at each location of the pattern based on the pixel intensity distribution and specified intensity thresholds for failures.

19. The medium of claim 18, wherein the specified intensity thresholds include an intensity threshold defined for a tone-flip failure based on full width half maximum (FWHM) of the pixel intensity distribution, an intensity threshold for a failure corresponding to pinching, and/or an intensity threshold corresponding to bridging.

20. The medium of claim 16, wherein the instructions are further configured to cause the one or more processors to determine an image representing at least one selected from: standard deviation, FWHM, and/or slope value of the pixel intensity distribution at each location of the pattern based on the pixel intensity distribution.
